(19) United States
(12) Patent Application Publication
(10) Pub. No.: US 2007/0115202 A1
(43) Pub. Date: May 24, 2007

(54) ELECTRONIC DEVICE WITH DUAL VIEW DISPLAYS

(76) Inventor: Josef R. Kiesenhofer, Durham, NC (US)

Correspondence Address: ADAMS EVANS P.A., 201 SOUTH COLLEGE STREET, SUITE 2350, CHARLOTTE, NC, 28244, US

(21) Appl. No.: 11/164,439

(22) Filed: Nov. 22, 2005

(51) Int. Cl. G09G 5/00

(52) U.S. Cl. 345/1.1

(57) ABSTRACT

An electronic device, such as a laptop computer, that includes a case containing electronic components suitable for processing digital data and generating a visual representation of the digital data for display. A first flat panel display is pivotally mounted on the case and is operatively connected to the electronic components for receiving and visually displaying data for viewing on a first side. A second flat panel display is mounted on the reverse side of the first display, or pivotally mounted on a top edge of the first display and operatively connected to the electronic components for receiving and visually displaying the data for being viewed simultaneously with the first display.

### TECHNICAL FIELD AND BACKGROUND OF THE INVENTION

This invention relates to an electronic device with a dual view display. The invention has a wide range of applications in portable electronic devices such as DVD players, laptop computers and similar devices where it is necessary or desirable for the images being displayed to be viewed simultaneously from different positions. For example, laptop computers are now commonly used in sales presentations, product demonstrations and in one-on-one training sessions. Unless the computer operator and the viewer are sitting next to each other, the operator must turn the computer to an oblique position where the viewer can see the screen. Viewing quality of most laptop displays is optimal from directly in front of the display, not at an oblique angle. Since the operator cannot turn the computer 180 degrees to his position and still operate the keyboard, presentations using laptop computers present problems that compromise other advantages inherent in the ability to use a small, portable, highly-adaptable laptop computer to present information in a sales, educational or other environment.

The present invention provides a solution that permits an operator and viewer to sit comfortably opposite each other with both having the ability to view an electronic device display from an ideal, generally perpendicular angle relative to their respective displays.

### SUMMARY OF THE INVENTION

Therefore, it is an object of the invention to provide an electronic device that has two displays for being viewed from opposite positions.

It is another object of the invention to provide an electronic device that has two displays for being viewed from opposite positions and at an optimal viewing angle.

These and other objects of the invention are achieved by providing an electronic device, comprising a case containing electronic components suitable for processing digital data and generating a visual representation of the digital data, a first flat panel display mounted on the case and operatively connected to the electronic components for receiving and visually displaying data for viewing, and a second flat panel display mounted for viewing from a position generally opposite the first display and operatively connected to the electronic components for receiving and visually displaying the data for being viewed simultaneously with the first display.

According to one embodiment of the invention, the electronic device comprises a laptop computer.

According to another embodiment of the invention, the electronic device comprises a laptop computer having a case cover mounted for pivotal movement to the case, and carrying the first display and second displays on opposite sides thereof.

According to yet another embodiment of the invention, the device includes a switch for allowing an operator of the electronic device to selectively blank the second display.

According to yet another embodiment of the invention, the first display is pivotally mounted relative to the case and the second display is pivotally mounted relative to the first display.

According to yet another embodiment of the invention, the first display is pivotally mounted on the case and the second display is pivotally on the first display.

According to yet another embodiment of the invention, a display cover is pivotally mounted on the case or the case cover for selective movement between an open position exposing the second display and a closed position covering the second display.

According to yet another embodiment of the invention, an electronic device is provided, comprising a case containing electronic components suitable for processing digital data and generating a visual representation of the digital data for display, a first flat panel display pivotally mounted on the case and operatively connected to the electronic components for receiving and visually displaying data for viewing on a first side thereof; and a second flat panel display mounted on a second side of the first display opposite the first side of the first display for viewing, and operatively connected to the electronic components for receiving and visually displaying the data for being viewed simultaneously with the first display.

According to yet another embodiment of the invention, the electronic components include first and second visual display pointers usable by first and second users of the electronic device to independently point to selected positions on the respective first and second displays.

According to yet another embodiment of the invention, a display cover is pivotally mounted on the case or the case cover for selective movement between an open position exposing the second display and a closed position covering the second display.

According to further embodiments of the invention, the display cover is transparent or opaque.

According to yet another embodiment of the invention, a laptop computer is provided, and comprises a case containing electronic components suitable for processing digital data and generating a visual representation of the digital data for display, a first flat panel display mounted on the case and operatively connected to the electronic components for receiving and visually displaying data for viewing on a first side thereof, and a second flat panel display mounted on a top edge of the first display for viewing, and operatively connected to the electronic components for receiving and visually displaying the data for being viewed simultaneously with the first display.

According to yet another embodiment of the invention, the first display is pivotally mounted and the second display is pivotally mounted.

According to yet another embodiment of the invention, the electronic components include first and second visual display pointers usable by first and second users of the electronic device to independently point to selected positions on the respective first and second displays.

According to yet another embodiment of the invention, a switch is provided for allowing an operator of the electronic device to selectively blank the second display.

According to yet another embodiment of the invention, the first display is mounted for pivotal movement between at least one viewing position and a storage position parallel to the case, and the second display is mounted for pivotal movement between at least one viewing position and a storage position parallel to the first display and the case.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a laptop computer having a dual view display;

FIG. 2 is a perspective view of the laptop computer of FIG. 1, showing the reverse side of the dual view display;

FIG. 3 is a perspective view of a laptop computer according to another embodiment of the invention, having a cover that protects the reverse side of the dual view display;

FIG. 4 is a perspective view of a laptop computer according to another embodiment of the invention, wherein two displays of pivotally-joined to permit the viewing angle to be optimized; and

FIG. 5 is a perspective view of the laptop computer shown in FIG. 4, viewed from the opposite side.

### DESCRIPTION OF THE PREFERRED EMBODIMENT AND BEST MODE

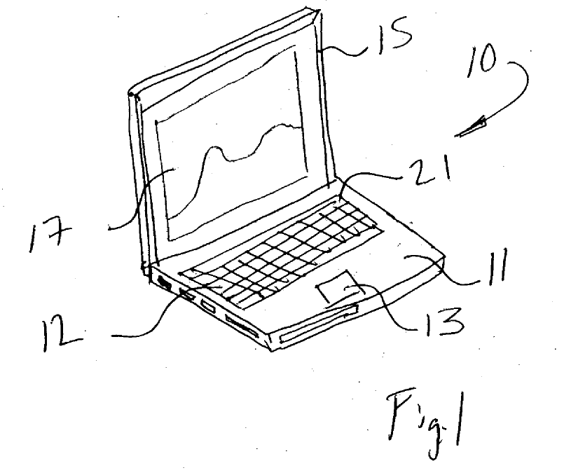

Referring now specifically to the drawings, a laptop computer according to the present invention is illustrated in FIG. 1 and shown generally at reference numeral 10. While the invention is described with specific reference to a laptop computer, the invention has application to any small electronic device where it is necessary or desirable for the display to be viewed simultaneously from different positions.

The computer 10 includes a case 11 that contains a microprocessor, memory, input-output devices, power supply and the like, a keyboard 12 and a touch-pad 13. A case cover 15 is mounted to the case 11 for adjustable pivotal movement between a closed position, not shown, and an open position for viewing a display screen 17 housed in the case cover 15.

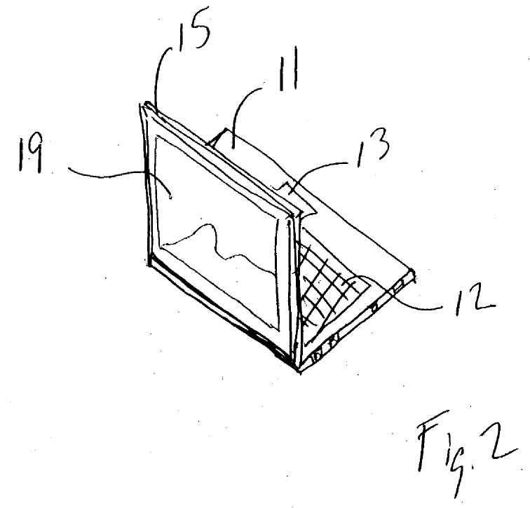

Referring now to FIG. 2, the case cover 15 also includes on a side opposite the display screen 17 a second display screen 19 which can be viewed from the opposite direction. In other words, a person , referred to as a “viewer”, sitting directly opposite the operator of the computer 10 can view exactly the same material being viewed by the operator at the same time. This permits the operator to maintain eye contact as necessary with the viewer in a manner not easily accomplished if the operator and the viewer are sitting next to each other.

Preferably, the computer 10 includes a key 21 that permits the operator to “blank”the display screen 19 when desired. This is particularly useful if the computer 10 is being used for testing, training, or other uses where the viewer should not see the display screen 19 at all times. Image signals to the display screen 19 are left-to-right reversed, i.e., both the operator and viewer are viewing the same image, including its left-to-right orientation. Thus, if the operator, viewing the display screen 17, directs the viewer's attention to material on the left side of the image, the viewer will see the desired material on the left side of the display screen 19.

The display screen 19 comprises a thin LCD or plasma display similar or identical to the display screen 17, with a suitable power supply and battery system to accommodate the increased power required to operate the second display screen 19. Of course, the thickness and weight of the case cover 15 are correspondingly increased. LCD or plasma displays are typically referred to as “flat panel” and used herein, the term “flat panel” display is intended to include, but not be limited to LCD and plasma displays, and excludes CRT and projection -type displays. Image signals and current are provided to the display screen 19 in the same manner as supplied to the display screen 17.

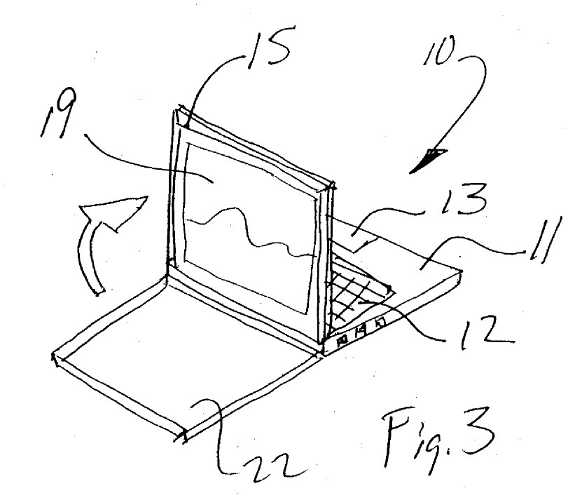

The display screen 19 may be protected by a thin plastic sheet that, if transparent, can remain in place during use, or be removed, as desired. Alternatively, as shown in FIG. 3, the computer 10 may be provided with a protective display screen cover 22 that may be removed when the display screen 19 is to be viewed, and left in place when only the display screen 17 is to be viewed. The display screen cover 22 may be metal, plastic or any other suitable material and is pivotally-mounted to the case 11.

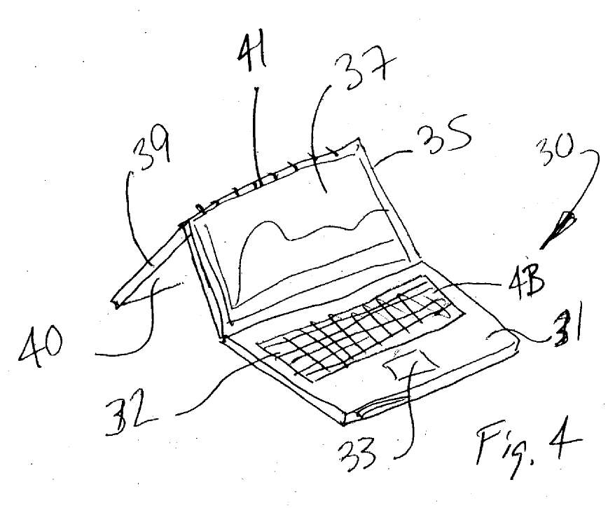

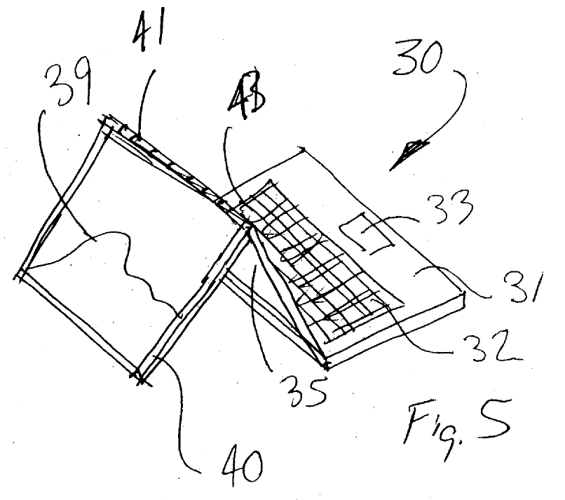

Referring now to FIGS. 4 and 5, an alternative embodiment of the laptop computer is shown and broadly indicated at reference numeral 30. The computer 30 includes a case 31 that contains a microprocessor, memory, input-output devices, power supply and the like, a keyboard 32 and a touch-pad 33. A case cover 35 is mounted to the case 31 for adjustable pivotal movement between a closed position, not shown, and an open position for viewing a display screen 37.

The computer 30 includes a second display screen 39 which can be viewed from the opposite direction. The display screen 39 is contained in a housing 40 that is preferably mounted by a hinge 41 to the top edge of case cover 35, and is pivotally moveable into a position where the display screen 39 is angled upwardly as desired for optimal viewing. Both the display screen 37 and the display screen 39 may be independently tilted by the respective operator and viewer to an optimal viewing position. The bottom edge of the housing 40 sits on a surface, such as a table or desk, and provides a stable support for the display screen 39. The necessary cables and wires may be routed through the cover 35 to the display screen 39, or along the back side of the cover 35.

When not in use the frame 40 and display screen 39 are folded up against the back side of the cover 35. The cover 35 is opened and closed as normal.

Preferably, the computer 30 includes a key 43 that permits the operator to “blank”the display screen 39 when desired. Image signals to the display screen 39 are left-to-right reversed, i.e., both the operator and viewer view the same image, including its left-to-right orientation. Thus, if the operator, as described above, directs the viewer's attention to the left side of the image, the viewer will see the desired material on the left side of the display screen 39.

The display screen 39 is preferably a thin LCD or plasma display similar or identical to the display screen 37, with a suitable power supply and battery system to accommodate the increased power required to operate the second display screen 39.

The computer is preferably provided with at least two USB or other accessory ports whereby both the operator and viewer have access to a mouse and can under appropriate circumstances independently use the mouse to navigate the display screens 37 and 39, respectively. Ideally, each mouse has a different appearance so that they are distinguishable by the operator and viewer.

The display screen 39 may be protected by a thin plastic sheet that, if transparent, can remain in place during use, or be removed, as desired. Alternatively, the laptop computer 30 may be provided with a protective cover, not shown, that may be removed when the display screen 39 is to be viewed, and left in place when only the display screen 37 is to be viewed. The cover may be metal, plastic or any other suitable material. Both laptop computers 10 and 30 will include a power supply that permits them to be powered by AC current in the usual manner.

An electronic device with dual view displays is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

What is claimed is:

1. An electronic device, comprising:
(a) a case containing electronic components suitable for processing digital data and generating a visual representation of the digital data;
(b) a first flat panel display mounted on the case and operatively connected to the electronic components for receiving and visually displaying data for viewing; and
(c) a second flat panel display mounted for viewing from a position generally opposite the first display and operatively connected to the electronic components for receiving and visually displaying the data for being viewed simultaneously with the first display.

2. An electronic device according to claim 1, wherein the electronic device comprises a laptop computer.

3. An electronic device according to claim 1, wherein the electronic device comprises a laptop computer having a case cover mounted for pivotal movement to the case, and carrying the first display and second displays on opposite sides thereof.

4. An electronic device according to claim 1, 2 or 3, and including a switch for allowing an operator of the electronic device to selectively blank the second display.

5. An electronic device according to claim 1, wherein the first display is pivotally mounted relative to the case and the second display is pivotally mounted relative to the first display.

6. An electronic device according to claim 1, wherein the first display is pivotally mounted on the case and the second display is pivotally on the first display.

7. An electronic device according to claim 1, and including a display cover pivotally mounted on the case or the case cover for selective movement between an open position exposing the second display and a closed position covering the second display.

8. An electronic device, comprising:
(a) a case containing electronic components suitable for processing digital data and generating a visual representation of the digital data for display;
(b) a first flat panel display pivotally mounted on the case and operatively connected to the electronic components for receiving and visually displaying data for viewing on a first side thereof; and
(c) a second flat panel display mounted on a second side of the first display opposite the first side of the first display for viewing, and operatively connected to the electronic components for receiving and visually displaying the data for being viewed simultaneously with the first display.

9. An electronic device according to claim 8, wherein the electronic device comprises a laptop computer.

10. An electronic device according to claim 8, wherein the electronic components include first and second visual display pointers usable by first and second users of the electronic device to independently point to selected positions on the respective first and second displays.

11. An electronic device according to claim 8, and including a display cover pivotally mounted on the case or the case cover for selective movement between an open position exposing the second display and a closed position covering the second display.

12. An electronic device according to claim 11, wherein the display cover is transparent.

13. An electronic device according to claim 11, wherein the display cover is opaque.

14. A laptop computer, comprising:
(a) a case containing electronic components suitable for processing digital data and generating a visual representation of the digital data for display; (b) a first flat panel display mounted on the case and operatively connected to the electronic components for receiving and visually displaying data for viewing on a first side thereof; and
(c) a second flat panel display mounted on a top edge of the first display for viewing, and operatively connected to the electronic components for receiving and visually displaying the data for being viewed simultaneously with the first display.

15. A laptop computer according to claim 14, wherein the first display is pivotally mounted and the second display is pivotally mounted.

16. A laptop computer according to claim 14, wherein the electronic components include first and second visual display pointers usable by first and second users of the electronic device to independently point to selected positions on the respective first and second displays.

17. A laptop computer according to claim 14, and including a switch for allowing an operator of the electronic device to selectively blank the second display.

18. A laptop computer according to claim 14, wherein the first display is mounted for pivotal movement between at least one viewing position and a storage position parallel to the case, and the second display is mounted for pivotal movement between at least one viewing position and a storage position parallel to the first display and the case.
